(19) United States
(12) Patent Application Publication
(10) Pub. No.: US 2002/0197590 A1
(43) Pub. Date: Dec. 26, 2002

(54) Arrangement for abacus-like calculation

(76) Inventor: Chiu Liang Gan, Singapore (SG)

Correspondence Address: Pandiscio & Pandiscio, 470 Totten Pond Road, Waltham, MA, 02451-1914, US

(21) Appl. No.: 10/127,652

(22) Filed: Apr. 22, 2002

(30) Foreign Application Priority Data
Apr. 23, 2001 (SG) 200102231-8

(51) Int. Cl. G06C 1/00; G09B 19/02

(52) U.S. Cl. 434/203; 434/189

(57) ABSTRACT

An arrangement for abacus-like calculation comprises a basic element comprising a first region with an array of first cells forming the first region, wherein each first cell represents a visual marking as to an assignment of each first cell, a second region with an array of second cells forming the second region, wherein each second cell represents a visual marking as to an assignment of each second cell, at least one first indicator unit accessed to the first region, wherein the relative arrangement between the first indicator unit and the first region is changeable in order to indicate a selected first cell of the array of first cells, and at least one second indicator unit accessed to the second region, wherein the relative arrangement between the second indicator unit and the second region is changeable in order to indicate a selected second cell of the array of second cells, wherein the visually marked assignment is marked on the basic element or on the indicator unit.

### REFERENCE TO PENDING PRIOR PATENT APPLICTION

This patent application claims benefit of pending prior Singapore Patent Application Serial No. 200102231-8, filed Apr. 23, 2001 by Gan Chiu Liang for ARRANGEMENT FOR ABACUS-LIKE CALCULATION, which patent application is hereby incorporated herein by reference.

### BACKGROUND OF THE INVENTION

The invention relates to an arrangement for abacus-like calculation, which can be used as a display board, as a score board, as a counter or as a calculator board.

An abacus represents a device which is used to perform arithmetic operations such as addition, subtraction, multiplication and division. The abacus has been used for thousands of years and has appeared in various forms in different countries. Small merchants in many countries use it to figure their accounts.

In its most widely used form, the abacus is a rectangular wooden frame with several parallel wires running across the width of the frame. Beads are strung on the wires and are used as counters. In a decimal system of numeration, the separate wires represent units, 10's, 100's, 1000's, and so on. On such a conventional abacus which does not employ a division bar, there are usually 10 beads on each wire, so that each bead stands for a unit of place value. Thus, each bead on the unit wire represents 1, each bead on the 10's wire represents 10, and so on.

The Chinese abacus comprises a division bar horizontally across the frame. Below the division bar units are counted up to five; the fives are transferred to the upper section, where each bead stands for five units.

Arithmetic teachers often use the abacus to give young students a better understanding of place value in the decimal system of numeration.

U.S. Pat. No. 3,731,401 discloses a mechanical abacus instruction apparatus comprising a frame defining a rectangular space, a plurality of beads shafts mounted on said frame at fixed intervals parallel to each other, a partition bar, a plurality of beads mounted on each shaft, wherein the partition bar divides the ensemble of the beads in an upper and a lower group, a numeral plate and a horizontally sliding answer indicating plate. Depending on the position of the upper beads the mechanical abacus instruction apparatus enables answer numerals to be exposed below the moved beads. Therefore the mechanical abacus instruction apparatus can serve as an instruction device for pupils and foreigners by displaying a numeral corresponding to the position of the upper beads.

The mechanical abacus instruction apparatus according to U.S. Pat. No. 3,731,401 has a drawback in that it requires a set of sliding numeral plates for displaying the numerical answer. These numeral plates represent a complex mechanical system which can easily cause trouble or failures of the abacus instruction apparatus.

One object of the present invention is to provide an arrangement for abacus-like calculation, which allows both an easy detection of the represented numbers as well as a simple mechanical construction.

### SUMMARY OF THE INVENTION

In order to achieve the above described object the present invention provides an arrangement for abacus-like calculation with a basic element comprising a first region with an array of first cells forming the first region, wherein each first cell represents a visual marking as to an assignment of each first cell, a second region with an array of second cells forming the second region, wherein each second cell represents a visual marking as to an assignment of each second cell, at least one first indicator unit accessed to the first region, wherein the relative arrangement between the first indicator unit and the first region is changeable in order to indicate a selected first cell of the array of first cells, and at least one second indicator unit accessed to the second region, wherein the relative arrangement between the second indicator unit and the second region is changeable in order to indicate a selected second cell of the array of second cells, wherein the visually marked assignment is marked on the basic element or on the indicator unit. The arrangement for abacus-like calculation has the advantage that it can be realized within a flat device so that it can be easily taken along within any trouser pocket.

According to an embodiment of the invention the visual markings represent numbers of a predefined number system, symbols represented by different colors, symbols represented by different color codes, symbols represented by different characters, symbols represented by different pictures, symbols represented by different icons and/or any other type of distinguishable symbols. Therefore the arrangement for abacus-like calculations can be employed as a counter, for performing calculations and/or for providing a base for playing games.

According to a preferred embodiment the visual markings of the first region represent the decimal system unit-place values and the visual markings of the second region represent the decimal system tenplace values. Since the decimal system is the most widely used number system the arrangement according to the invention can be widely employed.

According to a further embodiment of the invention a region is divided into two sub-regions and each cell of the first sub-region is counted multiple in comparison with the cells belonging to the second sub-region. The two sub-regions are separated by a division line. In case of calculating within the decimal numeral system it is preferred that the indicator units located within the first sub-region on the one side of the division line represent five times the decimal system place value than the indicator units located within the second sub-region on the other side of the division line. If a particular indicator unit has to be taken into account it has to be moved towards the division line. Therefore, since some indicator units are counted multiple, the arrangement for abacus-like calculation according to this further embodiment has the advantage that many numbers can be represented by a reduced number of indicator units. In particular when calculating within the decimal system any significant place value greater or equal than five can be represented by employing less indicator units in comparison to the case in which all cells within a certain region are counted equally.

According to a particular preferred embodiment the basic element and/or the indicator unit are made out of plastic, cardboard, paper, a magnetic material, a clothed-based material and/or any material which provides or which is coated with a write-erasable surface. This preferred embodiment has the benefit that the whole arrangement for abacus-like calculation can be made out of cheap and resistive materials.

The basic element can further comprise a region which is suitable for displaying further information. Further on the region being suitable for displaying further information can be used for displaying advertisements. Therefore the invention provides a display for advertisements, wherein the person using the arrangement for abacus-like calculation will pay attention to the advertisements displayed on the surface of the board.

According to another preferred embodiment the basic element further comprises a calendar, an arithmetic game and/or an attractive display. These features cause that the arrangement for abacus-like calculation will be widely used.

According to another embodiment the arrangement comprises a region for indication of a mathematical operation. In particular these mathematical operations can be addition, subtraction, multiplication and/or division. This embodiment of the present invention provides the possibility to teach children calculating.

The first indicator unit and/or the second indicator unit can be attached to the basic element via magnetic interaction, electrostatic interaction, gravitational interaction, sticking, clamping, a frictional wall grip and/or a recess and relief structure. Therefore many different kinds of attachment between the indicator units and the basic element can be used, allowing that the arrangement for abacus-like calculation can be realized with a great variety of different designs.

According to a further embodiment of the invention the basic element is a board. Using a board as the basic element has the advantage that the arrangement can be easily formed as a flat device.

According to another embodiment of the invention the board has a rectangular or a circular shape. Therefore the arrangement for abacus-like calculation can be realized by different geometric shapes in order to adapt the design to the different wishes of different users.

According to another preferred embodiment the board is a one-piece board or the board is made out of subunits which can reversible or irreversible be connected to each other. This embodiment has the advantage that also large area boards can be realized without occupying much space when the arrangement is stored or when the user or any other person handles the currently unused arrangement.

According to a further preferred embodiment of the invention the first region and the first indicator unit are arranged on the upper side of the board and the second region and the second indicator unit are arranged on the lower side of the board. By employing both the upper and the lower surface smaller boards can be used while the full functionality of the present invention is conserved.

According to another embodiment the board is made out of a waste product which arises when tokens are produced using a die cutting technique. This embodiment has the benefit that the production costs can significantly be reduced.

According to a further embodiment the board is made out of plastic, foam rubber, wood, metal, corrugated paper, cardboard and/or cork. Having the possibility to use different materials has the advantage that the arrangement according to the present invention can be widely used.

According to another embodiment of the invention the board further comprises a component which can be fold out of the plane of the board. Such a fold out component can be used for instance as a stand in order to make the arrangement for abacus-like calculation to stand alone in a predominantly vertical position. Another application of such a fold out component could be to use this component as a loop in order to hang the board for instance on a wall.

According to another particular preferred embodiment the indicator unit is a sash and the board comprises grooves or raised shoulders, which are capable of receiving at least a part of the sash. Employing a sash as a window-like indicator provides a clear indication of the numbers or symbols which are printed on the board.

According to a further embodiment of the present invention the grooves or raised shoulders have closed ends. This beneficial feature prevents that the indicator units can easily be removed and/or get lost.

Another preferred embodiment provides an arrangement for abacus-like calculation, wherein the indicator unit has a three-dimensional shape, which sectional profile is similar to the shape of a butterfly or which sectional profile is similar to a system consisting of two isosceles triangles placed opposite to each other while being connected to each other via a triangle vertex, the board comprises a slot and the indicator unit is attached to the board in that way, that the slot of the board and the point of intersection of the indicator unit coincide. This preferred embodiment has the advantage that the indicator units are fixed to the board. Therefore the indicator units can be flattened for compact storage.

According to a further preferred embodiment the first indicator unit and/or the second indicator unit comprise a plurality of individual sub-elements. Therefore the arrangement for abacus-like calculation can be conveniently used for playing a variety of different games.

According to another preferred embodiment the individual sub-element is a token or a numeral plate. This has the advantage that the assignment of the sub-element can easily be recognized by the user.

According to another preferred embodiment of the invention the upper surface of the individual sub-elements is not leveled with the upper surface of the board. This has the advantage that the individual sub-elements can easily be removed from the board and displaced on the board manually.

According to a further embodiment of the invention the individual sub-elements comprise lateral walls that are bevelled, clear-cut or even serrated. The serrated lateral walls are in particular advantageous if the board comprises cells formed in recesses which also comprise serrated lateral walls, wherein the serrated walls of the individual sub-elements and of the recesses form an interface which provides a high friction between the individual sub-elements and the recesses. In such a case the board can be turned upside down and the individual sub-element would not drop from the board.

According to a further embodiment of the invention the individual sub-elements have a circular shape with an inside hole and the board comprises circular raised platforms. This has the advantage that the individual sub-elements can be placed on the board in precisely predefined positions.

According to an embodiment of the invention the numeral plates can be reversibly taken away from or placed back onto the board. Therefore the invention can also be used conveniently for educational purposes in particular for teaching calculating mathematically.

According to another embodiment of the invention the numeral plates are sliding numeral plates which are movably attached to the board. This embodiment has the advantage that the numeral plates cannot be lost from the board.

According to a modified embodiment of the invention the first indicator unit and the second indicator unit are integrally formed within one single piece. Further on the first indicator unit can be a first window and the second indicator unit can be a second window. Therefore the indicator units are always linked together such that the user can conveniently read the calculation result.

According to a further preferred embodiment the first region has the shape of a first strip, the second region has the shape of a second strip, the first strip is movably attached to the first indicator unit and the second strip is movably attached to the second indicator unit. The arrangement has the advantage that it can be realized within a simple mechanical structure.

According to another preferred embodiment the first strip comprises a series of first numeral markings located such that one of the first numeral markings can be placed in the middle of the first window and the second strip comprises a series of second numeral markings located such that one of the second numeral markings can be placed in the middle of the second window. The arrangement has the advantage that it can be easily operated.

According to an embodiment of the invention the first strip and/or the second strip comprise enlarged ends in order to prevent the first strip and/or the second strip from slipping out of the first window and/or the second window, respectively. Therefore the strips cannot be lost from the indicator device.

According to another embodiment of the invention the first and the second strip are coiled such that the two ends of each strip are joined together. Therefore a three dimensional arrangement for abacus-like calculations is provided, which can conveniently be used as a counter.

The arrangement for abacus-like calculations can also be simulated by a computer program. In case of a computer simulation by employing a software solution of the present invention the board, the indicator units and all other elements of the above described arrangement are simulated by a graphical output. Therefore the board, the indicator units and all other elements of the above described arrangement are only virtually existent and are not physically touchable. Using a computer mouse, a computer keyboard or any other computer input peripheral enables the user to virtually operate the arrangement for abacus-like calculations. It has to be pointed out that the invention can also be realized by employing hardware or any combination of hardware and software.

The above and other objects, features and advantages of the present invention will become apparent from the following description and the appended claims, taken in conjunction with the accompanying drawing.

### BRIEF DESCRIPTION OF THE DRAWINGS

FIG. 1a shows an arrangement for abacus-like calculation according to a first embodiment of the present invention.

FIG. 1b shows a first alternative of the arrangement for abacus-like calculation according to the first embodiment of the present invention.

FIG. 1c shows a second alternative of the arrangement for abacus-like calculation according to the first embodiment of the present invention.

FIG. 2a shows an arrangement for abacus-like calculation according to a second embodiment of the present invention before performing a calculation.

FIG. 2b shows an arrangement for abacus-like calculation according to a second embodiment of the present invention after performing a calculation.

FIG. 2c shows an arrangement for abacus-like calculation according to a layout variation of the second embodiment of the present invention after performing a calculation.

FIG. 2d shows a part of an arrangement for abacus-like calculation wherein numbers are printed on the indicators.

FIG. 2e shows a part of an arrangement for abacus-like calculation wherein indicators cover certain numbers which are printed on a board.

FIG. 2f illustrates a first way of attaching indicators on a board.

FIG. 2g illustrates a second way of attaching indicators on a board.

FIG. 3a shows an arrangement for abacus-like calculation according to a third embodiment of the present invention.

FIG. 3b shows a sectional view of the first indicator unit used in connection with the third embodiment of the present invention.

FIG. 4 shows an arrangement for abacus-like calculation according to a fourth embodiment of the present invention.

FIG. 5 shows an arrangement for abacus-like calculation implemented on a circular board according to a fifth embodiment of the present invention.

FIGS. 6a, 6b and 6c show three arrangements for abacus-like calculation according to a sixth embodiment of the present invention.

FIG. 7 shows an arrangement for abacus-like calculation according to a seventh embodiment of the present invention, which embodiment is similar to the third embodiment shown in FIG. 3a.

FIG. 8a shows an arrangement for abacus-like calculation according to an eighth embodiment of the present invention, which embodiment can be used for educational purposes.

FIG. 8b shows the back side of the arrangement shown in FIG. 8a.

FIG. 8c shows a plurality of removable numeral plates corresponding to the back side of the arrangement shown in FIG. 8a.

FIG. 8d shows an answer checking device corresponding to the back side of the arrangement shown in FIG. 8a.

FIG. 9a shows an arrangement for abacus-like calculation according to a ninth embodiment of the present invention, which arrangement comprises strips and an indicator device formed by a fixed series of aligned windows.

FIG. 9b shows a slight modification of the ninth embodiment of the present invention which is similar to the embodiment shown in FIG. 9a.

FIG. 9c shows a modified three-dimensional alternative version of the ninth embodiment shown in FIG. 9b.

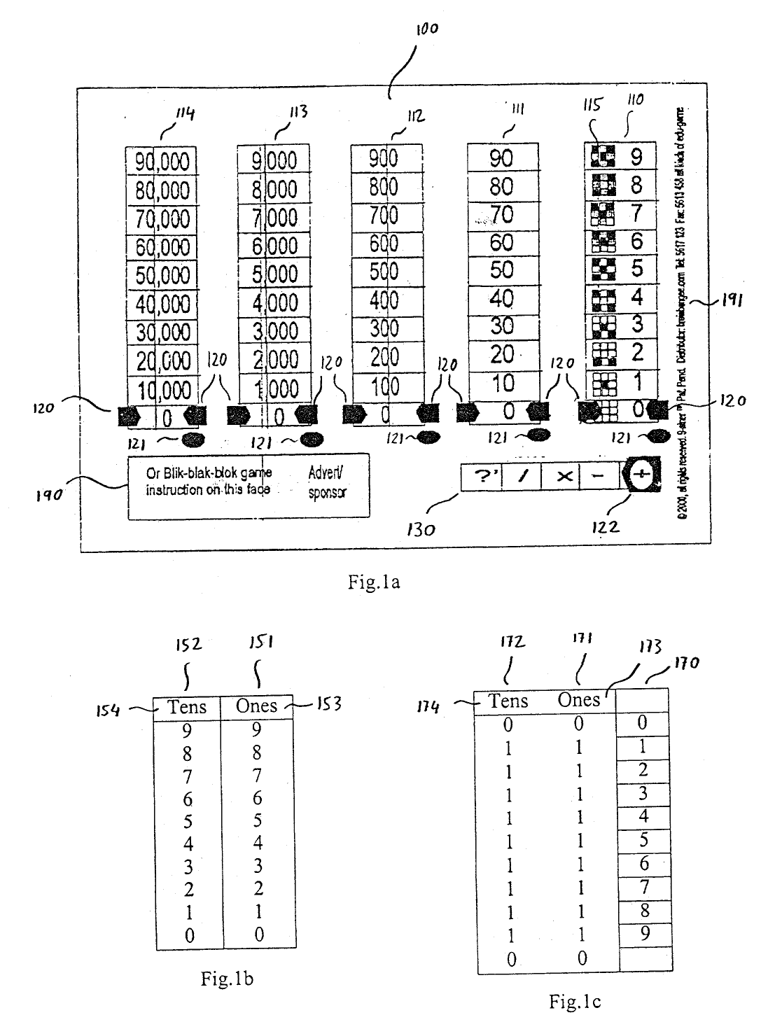

FIG. 1a shows an arrangement for abacus-like calculation according to a tenth embodiment of the present invention.

FIG. 10b shows a first side view of the arrangement for abacus-like calculation shown in FIG. 10a.

FIG. 10c shows a second side view of the arrangement for abacus-like calculation shown in FIG. 10a.

FIG. 10d shows a sectional view of the cardboard along the line X-X shown in FIG. 10a.

FIG. 11a shows an arrangement for abacus-like calculation according to an eleventh embodiment of the present invention.

FIG. 11b shows a slight modification of the eleventh embodiment of the present invention, which embodiment is similar to the embodiment shown in FIG. 11a.

FIGS. 11c and 11d show sectional views along the lines X-X indicated in FIGS. 11a and 11b.

FIGS. 11e, 11f and 11g show different possibilities for lateral interfaces between the tokens and the slots.

FIG. 12 illustrates a further possibility for positioning a token.

### DETAILED DESCRIPTION OF THE INVENTION

In the following a first preferred embodiment of the present invention is described with reference to FIG. 1a, FIG. 1b and FIG. 1c. The abacus device shown in FIG. 1a includes a rectangular board 100 providing the base of the arrangement for abacus-like calculation. On the board 100 there are located five different regions 110, 111, 112, 113 and 114. Each of these five regions 110, 111, 112, 113 and 114 is divided into ten cells. Each cell is marked with a different decimal number, wherein the cells within the first region 110 are marked with the unit-place values (0, 1, 2, 3, 4, 5, 6, 7, 8, 9), the cells within the second region 111 are marked with the ten-place values (0, 10, 20, 30, 40, 50, 60, 70, 80, 90), the cells within the third region 112 are marked with the hundred-place values (0, 100, 200, 300, 400, 500, 600, 700, 800, 900), the cells within the fourth region 113 are marked with the thousand-place values (0, 1000, 2000, 3000, 4000, 5000, 6000, 7000, 8000, 9000) and the cells within the fifth region 114 are marked with the ten thousand-place values (0, 10000, 20000, 30000, 40000, 50000, 60000, 70000, 80000, 90000). It is emphasized that the markings of the cells forming the regions 110, 111, 112, 113 and 114 could also be located next to the corresponding cells.

On the board 100 there are located a plurality of indicator units. In particular there are located ten first kind indicators 120, five second kind indicators 121 and one third kind indicator 122. All these indicators 120, 121 and 122 are magnetic type indicators, i.e. the indicators 120, 121 and 122 are attached to the board by magnetic interaction. Therefore the board 100 contains a magnetic material. The magnetic indicators 120, 121 and 122 can manually be moved over the entire surface of the board 100.

The board 100 also includes a region 130 which comprises cells displaying symbols representing the arithmetic symbols for addition, subtraction, multiplication and division. The region 130 further comprises a cell which shows the sign of interrogation. Employing the third kind indicator 122 the user can easily teach a child executing mathematical operations.

The board 100 also includes two regions 190 and 191 which can be used for displaying further information. According to the first embodiment of the present invention the region 190 is used for displaying an advertisement and the region 191 is used for displaying patent, copyright or other rights related to the present invention. Of course the regions 190 and 191 could also be used for displaying instructions and/or any other information.

Within the cells forming the first region 110 on the left side of the printed numbers (0, 1, 2, 3, 4, 5, 6, 7, 8, 9) there are further included ten small icons 115 which also represent the numbers (0, 1, 2, 3, 4, 5, 6, 7, 8, 9). The icons 115 are characterized by nine quadratic pixels which can have either a dark or a light color.

According to a first alternative of the first preferred embodiment of the present invention the marking of the cells is different to the marking shown in FIG. 1a. As an example FIG. 1b shows such a different marking for the region 151 comprising the cells representing the unit-place values and the region 152 comprising the cells representing the ten-place values. According to this first alternative the regions 151 and 152 replace the regions 110 and 111 shown in FIG. 1a. Both regions 151 and 152 are marked with the unit-place values (0, 1, 2, 3, 4, 5, 6, 7, 8, 9). In order to indicate the different significance of the two regions 151 and 152 each of the two regions 151 and 152 include a header-field 153 and 154 above each column of unit-place values, respectively. It is emphasized that such a further alternative for lettering the cells within the regions could also be applied for the corresponding regions 112, 113 and 114.

According to a second alternative of the first preferred embodiment of the present invention the marking of the cells is different to the marking shown in FIG. 1a. As an example FIG. 1c shows such a different marking for the region 171 comprising the cells representing the unit-place values and the region 172 comprising the cells representing the ten-place values. According to this second alternative the regions 171 and 172 replace the regions 110 and 111 shown in FIG. 1a. The cells within the regions 171 and 172 are only marked with the values unit and zero. By contradiction to the first alternative shown in FIG. 1b each of the regions 171 and 172 comprise eleven cells which are placed within one column. The lowest and the highest cell within each region 171 and 172 are marked with the value zero. All other cells are marked with the value one. The zero values on both ends of the regions 171 and 172 facilitate the zero setting of the value represented by a certain region because two different cells can be used in order to avoid long movements with the corresponding magnetic indicator. In order to indicate the different significance of the two regions 171 and 172 each of the two regions 171 and 172 include one header-field 173 and 174 over each column of unit-place values, respectively. In order to indicate the value of the cells representing the selected number a further column 170 of numbers is located next to the region 171. Column 170 comprises the numbers indicating the first place values of the cells within the regions 171 and 172 located in the same row as the corresponding number of column 170. It is also clear that such an alternative for lettering the cells within the regions could also be applied for the corresponding regions 112, 113 and 114.

It is to be noted that in order to mark the different cells any combination of the above described alternatives can be used.

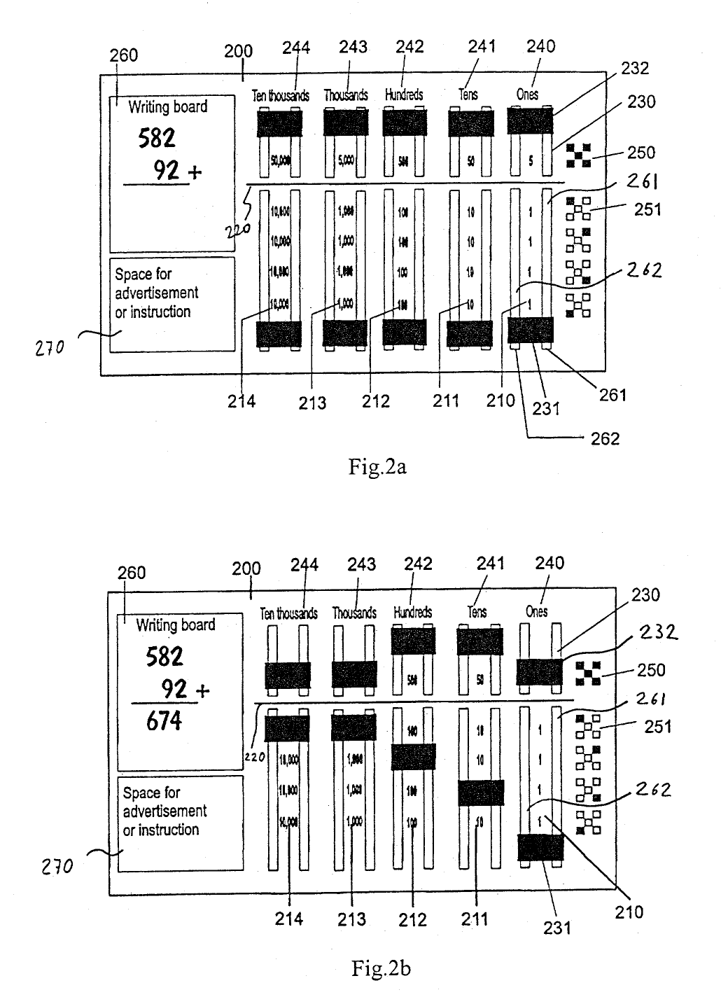

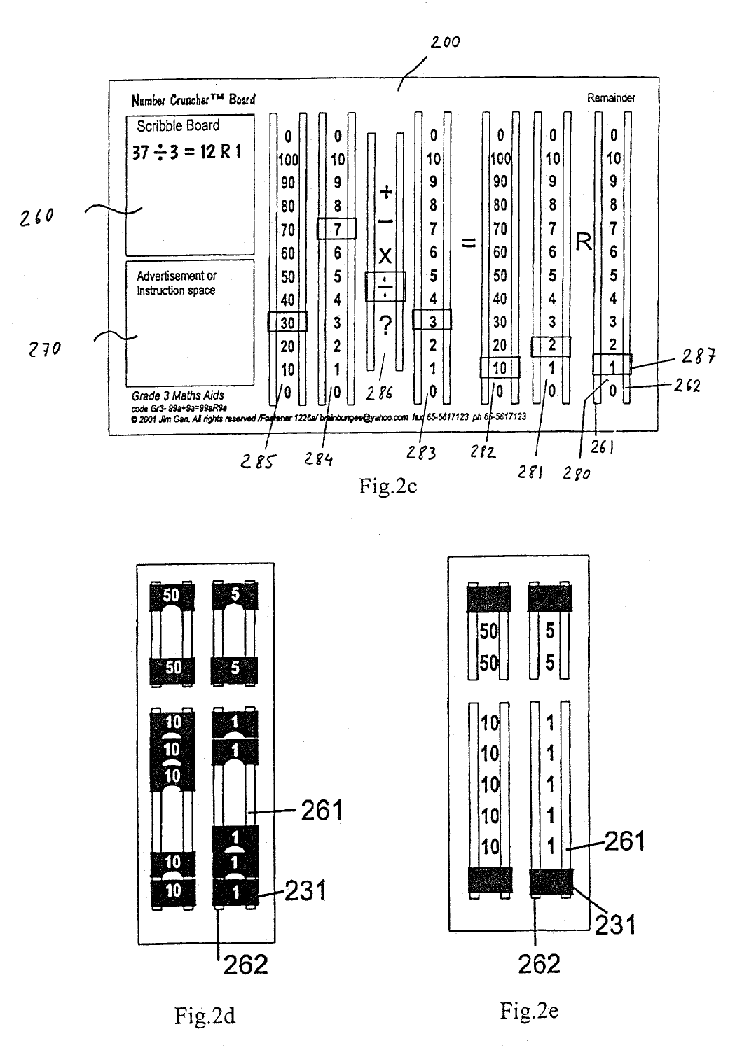

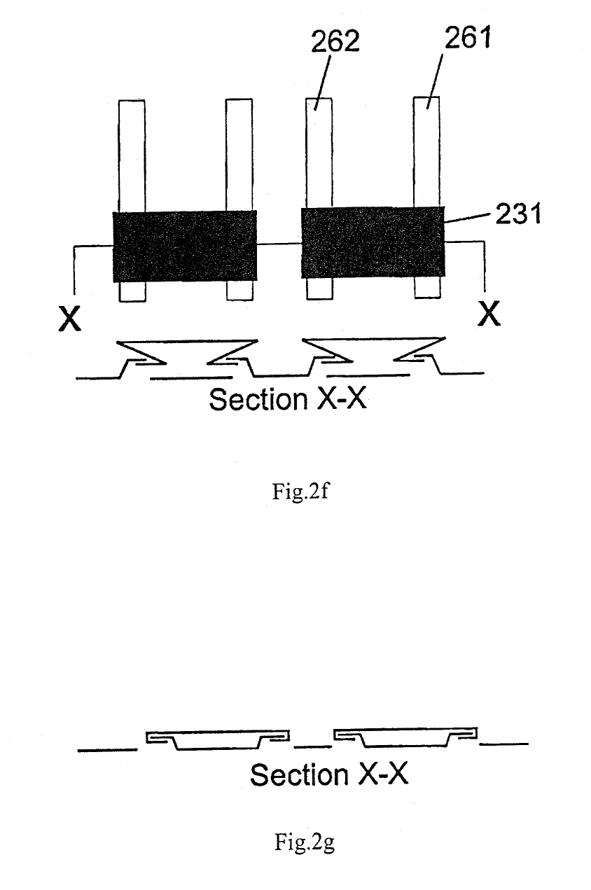

FIG. 2a shows an arrangement for abacus-like calculation according to a second embodiment of the present invention before performing a calculation. The device shown in FIG. 2a includes a rectangular plastic sheet board 200. On the surface of the board 200 there are located five different regions 210, 211, 212, 213 and 214. Each of these five regions 210, 211, 212, 213 and 214 comprises seven cells. The seven cells of each region are divided into two groups which are separated by a division bar 220. Above the division bar 220 there are located two cells, below the division bar 220 there are located five cells. Each region 210, 211, 212, 213 and 214 has two slit cuts located laterally of the five regions 210, 211, 212, 213 and 214. The slit cuts create raised shoulders 261, 262. The shoulders 261 are located on the left side of each region 210, 211, 212, 213 and 214. The shoulders 262 are located on the right side of each region 210, 211, 212, 213 and 214. The arrangement for abacus-like calculation further comprises sliding indicators 231, 232 which are engaged with the raised shoulders 261, 262. As shown in FIG. 2a the five regions 210, 211, 212, 213 and 214 are marked with the letterings “Ones” 240, “Tens” 241, “Hundreds” 242, “Thousands” 243 and “Ten thousands” 244, respectively. In order to further facilitate calculating with the arrangement for abacus-like calculation five from the seven cells of each region 210, 211, 212, 213 and 214 are marked with appropriate numbers in accordance with the calculation rules for the Chinese abacus. Below the division bar units are counted up to five and the fives are transferred to the upper section by moving an indicator unit which is located above the division bar 220 towards the division bar 220. Therefore, above the division bar 220 the lower cells of each region 210, 211, 212, 213 and 214 are marked with the numbers “5”, “50”, “500”, “5000” and “50000” and below the division bar 220 the upper four cells of each region 210, 211, 212, 213 and 214 are marked with the numbers “1”, “10”, “100”, “1000” and “10000”, respectively. The upper most and the lowest cells of each region 210, 211, 212, 213 and 214 are not marked at all. Since FIG. 2a shows the arrangement for abacus-like calculation before performing a calculation the five lower sliding indicators 231 which are located below the division bar 220 cover the lowest cells of each region 210, 211, 212, 213 and 214 while the five upper sliding indicators 232 which are located below the division bar 220 cover the upper most cells of each region 210, 211, 212, 213 and 214, respectively. The indicators 231 and 232 are ‘Gate’ type indicators which block or cover unwanted numbers “1”, “10”, “100”, “1000” or “10000” or “5”, “50”, “500”, “5000” or “50000”. To read off the number indicated on the board 200 only the numbers between the upper gate 232 and the lower gate 231 of each region 210, 211, 212, 213 and 214 are counted. As shown in FIG. 2a all the upper gates 232 are positioned in their upper most position and all the upper gates 231 are positioned in their lowest position. Therefore, the total number displayed on the board 200 shown in FIG. 2a is 55555. Before starting a calculation all the movable gates 231 and 232 have to be moved towards the division bar 220.

According to the present invention the division bar 220 is printed on the board 200. It is clear that the division bar 220 could also be a small rail or a type of shoulder which protrudes from the board 200. On the right side of cells within the region 210 there are further located five small icons 250 and 251 which represent the numbers “1”, “2”, “3”, “4” and “5”. The icons 250 and 251 are characterized by several quadratic pixels which can have either a dark or a light color.

On the left side of the board 200 there is located a region 260 which according to the present invention is used as a writing board. This region can be employed for instance to display a mathematical task. Below the region 260 there is located a further region 270 which according to the second embodiment of the present invention is used to display an advertisement and/or instructions for using the arrangement for abacus-like calculation.

At this point it has to be pointed out that according to the present invention the arrangement for abacus-like calculation is not restricted to five regions representing the decimal system unitplace, the decimal system ten-place, the decimal system hundred-place, the decimal system thousandplace and the decimal system ten thousand-place. Regarding the maximum number which can be represented by the arrangement for abacus-like calculation there is no principal limitation. Of course the arrangement for abacus-like calculation can also comprise less than five regions. It is further emphasized that the abacus device can also be useful when any different number system such as the hexadecimal system is employed.

FIG. 2b shows the arrangement for abacus-like calculation according to the second embodiment of the present invention after performing a calculation. As indicated on the region 260 the mathematical task of adding the “582” and “92” had to be solved. The solution of this task is “674”. Therefore, in accordance with the calculation rules described above, in the region 212 the value “600” is displayed between the upper gate 232 and the lower gate 231, in the region 211 the value “90” is displayed between the upper gate 232 and the lower gate 231 and in the region 210 the value “4” is displayed between the upper gate 232 and the lower gate 231, respectively.

FIG. 2c shows an arrangement for abacus-like calculation according to a layout variation of the second embodiment of the present invention after performing a calculation. On the surface of the plastic board 200 there are located six different regions 280, 281 282, 283, 284 and 285. Each of these six regions 280, 281, 282, 283, 284 and 285 comprises twelve cells. By contrast to the arrangement for abacus-like calculation according to the second embodiment of the present invention shown in FIG. 2a the arrangement for abacus-like calculation shown in FIG. 2c does not comprise division bar. Therefore all the twelve cells within one of the six regions 280, 281, 282, 283, 284 and 285 have the same numeral assessing. The twelve cells belonging to the regions 280, 281, 283 and 284 are marked with the numbers “0”, “1”, “2”, “3”, “4”, “5”, “6”, “7”, “8”, “9”, “10” and again “0”, respectively. The twelve cells belonging to the regions 282 and 285 are marked with the numbers “0”, “10”, “20”, “30”, “40”, “50”, “60”, “70”, “80”, “90”, “100” and “0”, respectively. On the surface of the plastic board 200 there is located a further region 286. This region 286 comprises five cells which are marked with the symbols “+”, “−”, “×”, “÷” and “?”.

Equally to the arrangement for abacus-like calculation shown in FIGS. 2a and 2b each region 280, 281, 282, 283, 284, 285 and 286 has two slit cuts located laterally of the seven regions 280, 281, 282, 283, 284, 285 and 286. The slit cuts create raised shoulders 261, 262. The shoulders 261 are located on the left side of each region 280, 281, 282, 283, 284, 285 and 286. The shoulders 262 are located on the right side of each region 280, 281, 282, 283, 284, 285 and 286.

By contrast to the arrangement for abacus-like calculation shown in FIGS. 2a and 2b the arrangement for abacus-like calculation shown in FIG. 2c does not employ ‘gate’ type indicators which block or cover unwanted numbers or symbols. The seven indicators 287 employed in the arrangement for abacus-like calculation shown in FIG. 2c are sliding ‘window’ type indicators 287. The indicators 287 are accessed to the seven regions 280, 281, 282, 283, 284, 285 and 286, The sliding ‘window’ type indicators 287 are engaged with the raised shoulders 261, 262. In order to indicate a certain cell of the seven regions 280, 281, 282, 283, 284, 285 and 286 the sliding ‘window’ type indicators 287 are moved along the raised shoulders 261 and 261 such that the desired numerals marked on a certain cell of the seven regions 280, 281, 282, 283, 284, 285 and 286 are placed in the middle of the ‘window’ type indicators 287. The indicators 287 can be for instance a color shaded transparent plastic clip or a sash clip.

Above the region 280 there is printed the word “Remainder” in order to indicate that it is supposed to only use the region 280 when a mathematical division operation has to be evaluated which does not lead to a integral result. It is clear that of course other words like for instance “Decimal” can be used in order to indicate the functionality of the region 280.

The board 200 of the arrangement for abacus-like calculation shown in FIG. 2c further comprises two regions 260 and 270. The functionality of these regions 260 and 270 is the same as has been described before in connection with the description of FIGS. 2a and 2b.

FIG. 2d shows a part of an arrangement for Chinese abacus-like calculation wherein numbers are printed on the indicators 231 which are slidingly attached to board via the raised shoulders 261 and 262. Each of the indicators 231 comprises a small semi-circular cut-out in order to facilitate slipping with a finger in between two adjacent indicators 231 which are in close proximity.

FIG. 2e shows a part of an arrangement for Chinese abacus-like calculation wherein indicators cover certain numbers which are printed on a board. The indicators 231 are slidingly attached to board via the raised shoulders 261 and 262.

FIG. 2f illustrates a first way of attaching indicators 231 on a board via the raised shoulders 261 and 262. The sliding indicators 231 are of a three dimensional shape as shown in the lower part of FIG. 2f which is a sectional view along the line X-X indicated in the upper part of FIG. 2f. The indicators 231 are made out of an elastic material in order that they can be inserted underneath the raised shoulders 261 and 262 by compressing or bending the indicators 231 along the line X-X.

FIG. 2g illustrates a second way of attaching indicators 231 on a board via the raised shoulders 261 and 262. The sliding indicators 231 are of a three dimensional shape as shown in FIG. 2g. The three dimensional shape is similar to the letter ‘C’ written in a cornered way. The ‘C’-shape indicator 231 is also made out of a material that can be elastically stretched in order to fit around the raised shoulders 261 and 262.

At this point it is emphasized that the two ways of attaching indicators to the board illustrated in FIGS. 2f and 2g have the benefit that the raised shoulders 261 and 262 do not have an open end. This ensures that the indicators can not easily be removed or lost from the board.

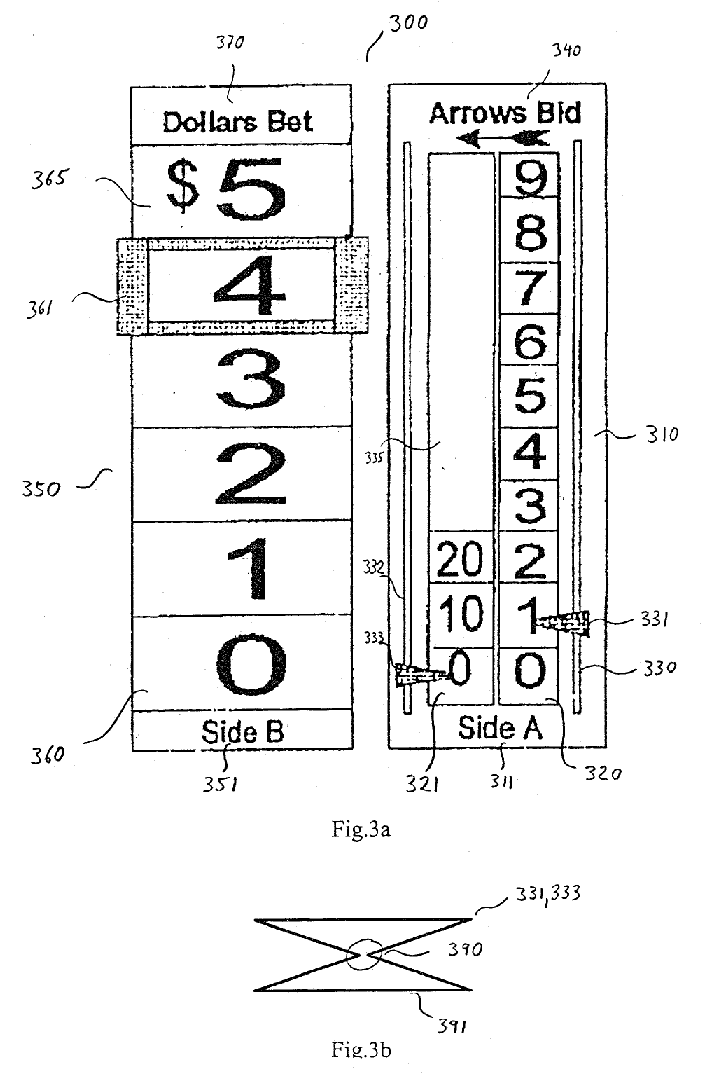

FIG. 3a shows an arrangement for abacus-like calculation according to a third embodiment of the present invention. The board 300 has an upper surface 310 and a lower surface 350. On the bottom of the upper surface 310 there is printed a lettering 311 which indicates that the upper surface 310 is denoted side A. On the bottom of the lower surface 350 there is printed a lettering 351 which indicates that the lower surface 350 is denoted side B.

On the upper surface 310 of the board 300 there is a first region 320. The first region 320 is divided into ten cells. Each cell is marked with a different decimal number representing the unit-place values (0, 1, 2, 3, 4, 5, 6, 7, 8, 9). On the right hand side of the first region 320 there is located a first slot 330. The slot 330 extends from the lower part of the first region 320 up to the upper part of the first region 320. Within the slot 330 there is located a first indicator 331 which can be moved manually along the slot 330. In a top view the first indicator 331 has the shape of an isosceles triangle, wherein a vertex of the triangle looks towards the cells forming the first region 320.

The first indicator 331 has a three dimensional shape. FIG. 3b shows a sectional view perpendicular to the slot 331 of the first indicator 331. The sectional profile of 331 and 333 is similar to the shape of a butterfly. The profile form could also be described to be similar to the shape of the Arabic number “8” or to be similar to a system consisting of two isosceles triangles, which are placed opposite to each other while being connected to each other via a triangle vertex. In all the three cases the sectional profile is compressed in a direction perpendicular to the surface of the board 300. Therefore the vertical extension of the indicator 331 is much smaller than its horizontal extension. The indicator 331 is attached to the board 300 in that way, that the slot 330 of the board and the point of intersection 390 of the indicator unit 331 coincide.

At this point it has to be pointed out that the board 300 is made out of two separate boards (not shown). A first separate board provides the base for the upper surface 310 of the board 300. A second separate board provides the base for the lower surface 350 of the board 300. The two separate boards are attached to each other by gluing. The glue between the two separate boards is only located at predefined areas ensuring that the indicators 331 and 333 are movable within the slots 330 and 332. The usage of the two separate boards ensures also that the lower parts 391 of the indicator units 331 and 333 are not seen on the lower surface 350 of the board 300.

On the lower surface 350 of the board 300 there is further a second region 321. The second region 321 is divided into four cells. Three of the four cells are of quadratic shape and are marked with a different decimal number representing the ten-place values (0, 10, 20). One of the four cells does not have a quadratic form. This long rectangular cell 335 occupies an area which is seven times as big as the size of the other quadratic cells. According to the described third embodiment the cell 335 does not comprise any numerals. It should be clear that the maximum value which can be represented by the indicators 331 and 333 could easily be extended by printing further ten-place values on the surface of the cell 335.

On the left hand side of the first region 321 there is located a second slot 332. The slot 332 extends from the lower part of the second region 321 up to the upper part of the second region 321. Within the slot 332 there is located a second indicator 333 which can be moved manually along the slot 332. In a top view the second indicator 333 has also the shape of an isosceles triangle, wherein a vertex of the triangle looks towards the cells forming the first region 321.

The shape of the second indicator 333 and the way of attaching the second indicator 333 to the board 300 is the same as the shape of the first indicator 331 and the way of attaching the first indicator 331.

On top of the upper surface 310 of the board 300 there is further located a lettering 340. This lettering 340 comprising the words “Arrow Bid” and describes the stake of the bet or the stake of the bid a player uses for the bet in a concealed or hidden bet duel.

The lower surface 310 of the board 300 comprises a region 360 which is divided into six rectangular cells. Each cell is marked with a different decimal number representing the unit-place values (0, 1, 2, 3, 4, 5). The third embodiment of the present invention is mainly designed for using the arrangement for abacus-like calculation in connection with betting. Therefore the marking of the cell 365 also includes a “Dollar” symbol indicating that the stake of the bet is considered to be money. The indicator 361 which indicates the stake is a sash which can be manually shifted along the board 300. The indicator 361 has the shape of a window. The indicator 361 is attached to the board 300 by clamping. As described above the board 300 is made out of two separate boards (not shown). Therefore the back side of the indicator 361 which is necessary for attaching the sash to the board is not seen on the upper surface 310 of the board 300. It is clear that the gluing between the two separate boards also has to take into account the movement of the indicator 361, in particular the movement of the back side of the indicator 361 necessary for attaching the indicator sash to the board 300.

On top of the lower surface 350 of the board 300 there is further located a lettering 370 indicating that the board 300 is considered to be used in connection with betting.

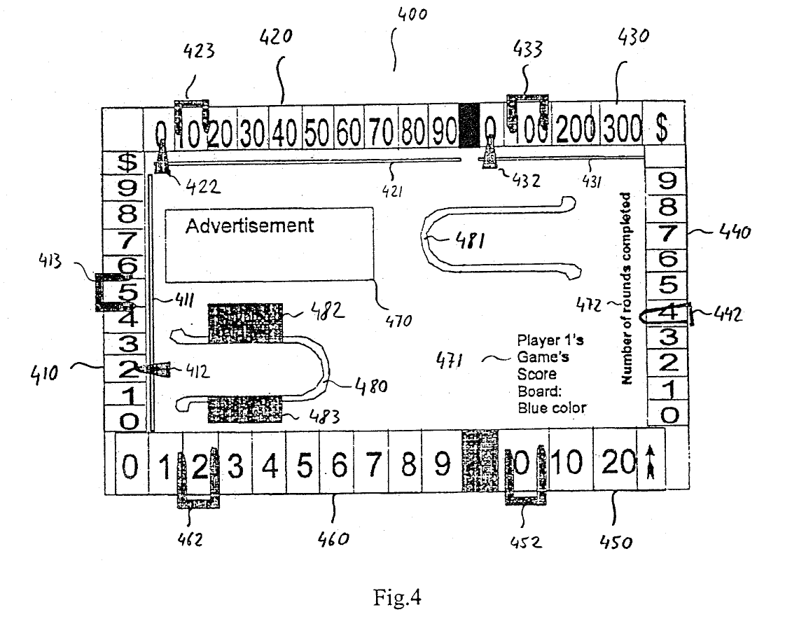

FIG. 4 shows an arrangement for abacus-like calculation according to a fourth embodiment of the present invention, which is considered to be used as a score board. The arrangement for abacus-like calculation comprises a rectangular board 400. On the board 400 there are located six regions 410, 420, 430, 440, 450 and 460, which are all located close to the four edges of the rectangular board 400.

The first region 410 is divided into ten cells. The cells within the first region 410 are marked with the unit-place values (0, 1, 2, 3, 4, 5, 6, 7, 8, 9). The second region 420 is also divided into ten cells. The cells within the second region 420 are marked with the ten-place values (0, 10, 20, 30, 40, 50, 60, 70, 80, 90). The third region 430 is divided into four cells. The cells within the third region 430 are marked with the hundred-place values (0, 100, 200, 300).

Next to the each region 410, 420 and 430 there are located a three slots 411, 421 and 431, respectively. With each of the slots 411, 421 and 431 there are engaged three triangle shaped indicators 412, 422 and 432, respectively. The indicators 412, 422 and 432 have a similar shape as the indicators 331 and 333 described above in connection with the description of FIG. 3a. The way how the indicators 412, 422 and 432 are attached to the board 400 is the same as described above and will therefore not be described again. According to the fourth embodiment of the invention the indicators 412, 422 and 432 can be used to indicate the score of the first player.

On the edge of the regions 410, 420 and 430 there are attached three clips 413, 423 and 433, respectively. Usual paperclips can be used to serve as the clips 413, 423 and 433. The clips according to the invention comprise a U-shape. The numbers printed within the three regions 410, 420 and 430 are indicated by the clips 413, 423 and 433, respectively. The numbers are displayed in the middle of the U-shape indicators 413, 423 and 433. According to the fourth embodiment of the invention the indicators 413, 423 and 433 can be used to indicate the score of the second player.

At this point it is emphasized that of course the maximum number of players which are involved in the score board can easily be increased by employing further clips which have for instance different colors or different shapes.

According to the fourth embodiment of the invention the fourth region 440 is used to display the numbers of rounds which have to be completed in order to finish the game. According to the forth embodiment of the present invention the number of rounds which have to be completed is indicated by an ordinary paperclip 442.

The fifth and the sixth region 450 and 460 on the board 400 can be employed for indication of a further number which is involved in the game. The corresponding numbers are indicated by two U-shaped indicators 452 and 462 which have are similar shape and which are attached in the same way as the indicators 413, 423 and 433.

The indicators 452 and 462 which can be moved along the fifths and the sixths region 450 and 460 indicate a numeral value of the amount of possessed property i.e. the number of bet stakes (arrows) owned by the player who uses the board 400.

On the board 400 there are also provided three regions 470, 471 and 472 which are used for displaying an advertisement, a first information related to the game and a second information related to the game, respectively. It is clear that also less or more regions for displaying any kind of information can be provided on the board 400.

The board 400 further comprises two clip holders 480 and 481 which are capable of receiving additional clips 482 and 483.

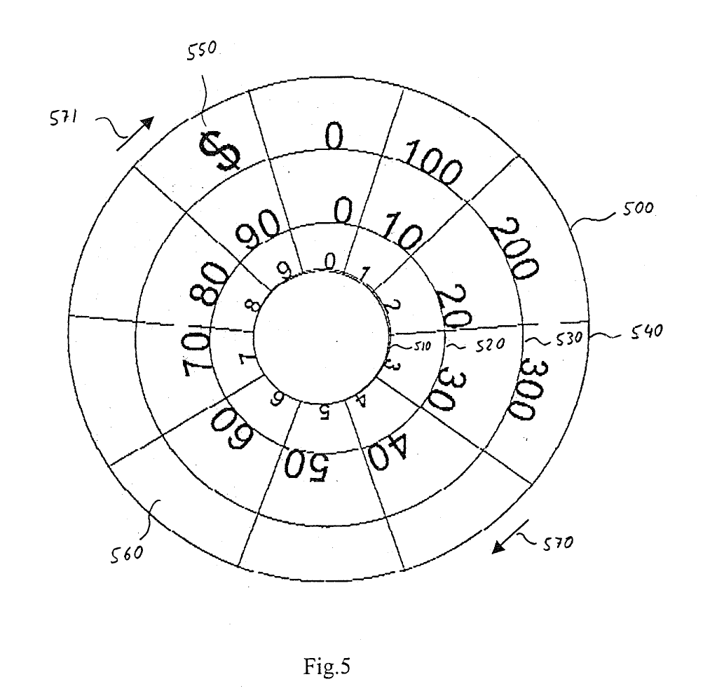

FIG. 5 shows an arrangement for abacus-like calculation implemented on a circular board 500 according to a fifth embodiment of the present invention. On the board 500 there are located four regions 510, 520, 530 and 540. The first region 510 which is located in the center of the circular board 500 is not used for employing the device according to the present invention. According to an alternative of the fifth embodiment of the present invention the first region 510 is used for displaying any kind of information. The second region 520 which is a concentric ring around the first region 510 comprises equally distributed printed markings which show the unit-place values (0, 1, 2, 3, 4, 5, 6, 7, 8, 9). The third region 530 which is a concentric ring around the second region 520 is divided into ten cells. The cells within this third region 530 are equally distributed marked with the ten-place values (0, 10, 20, 30, 40, 50, 60, 70, 80, 90). The fourth region 540 which is a concentric ring around the third region 530 is divided also into ten cells. Four cells out of these ten cells within the fourth region 540 are marked with the hundred-place values (0, 100, 200, 300). One cell out of the ten cells within the fourth region 540 is marked with a “Dollar” symbol 550. The other five cells such as cell 560 out of the ten cells within the fourth region 540 are not marked. The area of these five free cells can also be used to display any kind of information.

The circular layout of the arrangement for abacus-like calculation can be used with any kind of indicator unit. Since different kinds of indicator units have already been described above in detail, such indicator units are not included in FIG. 5 and will not be described once more. It is pointed out that according to a preferred alternative of the fifth embodiment magnetic indicators are used. But also other kinds of indicator units can be employed wherein some kinds of indicator units require also certain slots or grooves which have to be provided on the board 500 and which are also not shown in FIG. 5.

The circular layout of the arrangement for abacus-like calculation is especially appropriate to teach children counting. In this context the circular type of abacus device avoids the problem of an occasional discontinuous movement of the indicator units which is necessary with an abacus device employing columns instead of circular arranged cells. The circular type of abacus device also facilitates to teach children calculating the mathematical operations addition and subtraction. In case of performing an addition task the user has to move the corresponding indicator units in a clockwise direction which is depicted by the arrow 570. In case of performing an subtraction task the user has to move the corresponding indicator units in an anticlockwise direction which is depicted by the arrow 571.

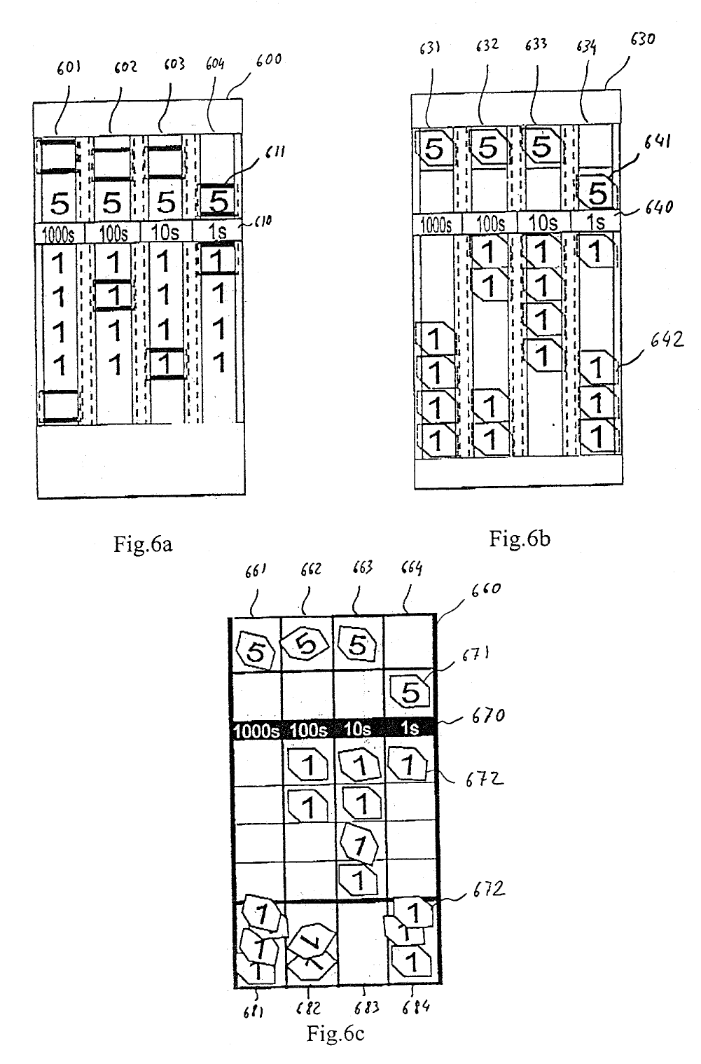

FIG. 6 shows three arrangements for abacus-like calculation according to a sixth embodiment of the present invention. This sixth embodiment is similar to the second embodiment shown in FIG. 2 and described earlier. The three arrangements shown in FIG. 6a, FIG. 6b and FIG. 6c only differ from each other with respect to the employed indicator units. All boards 600, 630 and 660 comprise on their surfaces four different regions representing the decimal system unit-place values, the decimal system ten-place values, the decimal system hundred-place values and the decimal system thousand-place values. The board 600 comprises the regions 601, 602, 603 and 604. The board 630 comprises the regions 631, 632, 633 and 634. The board 660 comprises the regions 661, 662, 663 and 664. Each region 601, 602, 603,. 604, 631, 632, 633, 634, 661, 662, 663 and 664 comprises seven cells. The seven cells of each region are divided into two groups which are separated by division bars 610, 640 and 670. Below the division bars 610, 640 and 670 units are counted up to five and full fives are transferred to the upper sections. For the convenience of the user the division bars 610, 640 and 670 are marked with printed numbers (Ones, Tens, Hundreds, Thousands and Ten Thousands) in order to indicate the significance value of the cells within the regions 601, 602, 603, 604, 631, 632, 633, 634, 661, 662, 663 and 664. As one can see all arrangements shown in the FIGS. 6a, 6b and 6c indicate the decimal system value 246.

FIG. 6a shows an arrangement for abacus-like calculation wherein sliding sashes 611 are employed in order to indicate a decimal system value. Therefore on the board 600 within each region 601, 602, 603 and 604 the number “1” is printed four times below the division bar 610 and the number “5” is printed one time above the division bar 610.

FIG. 6b shows an arrangement for abacus-like calculation wherein sliding numeral plates 641, 642 are employed in order to indicate a decimal system value. On all sliding numeral plates 641 which are located above the division bar 640 the decimal number “5” is printed on the upper surface of the numeral plates 641. On all sliding numeral plates 642 which are located below the division bar 640 the decimal number “1” is printed on the upper surface of the numeral plates 642.

FIG. 6c shows an arrangement for abacus-like calculation wherein removable numeral plates 641, 642 are employed in order to indicate a decimal system value. On all removable numeral plates 671 which are supposed to be located above the division bar 670 the decimal number “5” is printed on the upper surface of the numeral plates 671. On all removable numeral plates 672 which are supposed to be located below the division bar 670 the decimal number “1” is printed on the upper surface of the numeral plates 672. The lowest cells 681, 682, 683 and 684 of the regions 661, 662, 663 and 664 comprise a larger area in order to provide space to store numeral plates 672 which are not actually needed to indicate the decimal system value.

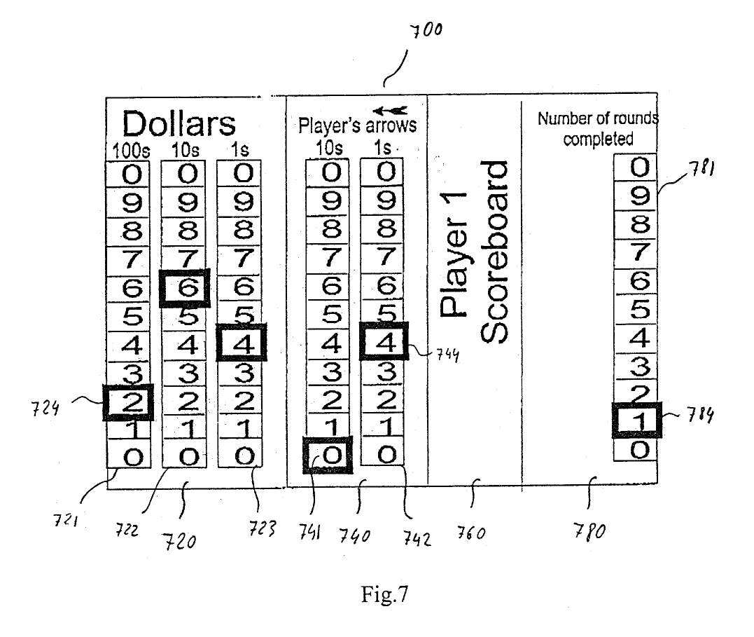

FIG. 7 shows an arrangement for abacus-like calculation according to a seventh embodiment of the present invention. This seventh embodiment is similar to the third embodiment shown in FIG. 3a and described earlier. By contrast to the board 300 shown in FIG. 3a the board 700 employs only one side of the board in order to indicate decimals system values.

The board 700 comprises four partitions 720, 740, 760 and 780. The first partition 720 is used to display the actual score. Therefore the first partition 720 comprises three regions 721, 722 and 723, wherein the actual score is indicated by three sashes 724. The second partition 740 is used to display the stake of the bet. This feature is indicated by the marking “Player's arrow” located on the upper part of the second partition 740. The second partition 740 comprises two regions 741 and 742, wherein the actual stake of the bet is indicated by two sashes 744. The third partition 760 of the board 700 is used for display purposes. As shown in FIG. 7 the third partition 760 of the board 700 comprises the marking “Player 1” and “Scoreboard”. This indicates the person using the board 700 as a scoreboard. It is clear that the third partition 760 can also be omitted or used to display any other information. According to the present invention the forth partition 780 is used to indicate the number of rounds which have already been completed. Therefore the fourth partition 780 comprises a region 781, wherein the number of rounds which have already been completed is indicated by a sash 784. It is also clear that a second region or even further regions could also be located in the fourth partition 780 in order in provide the possibility to indicate more rounds which have been completed or which have to be completed.

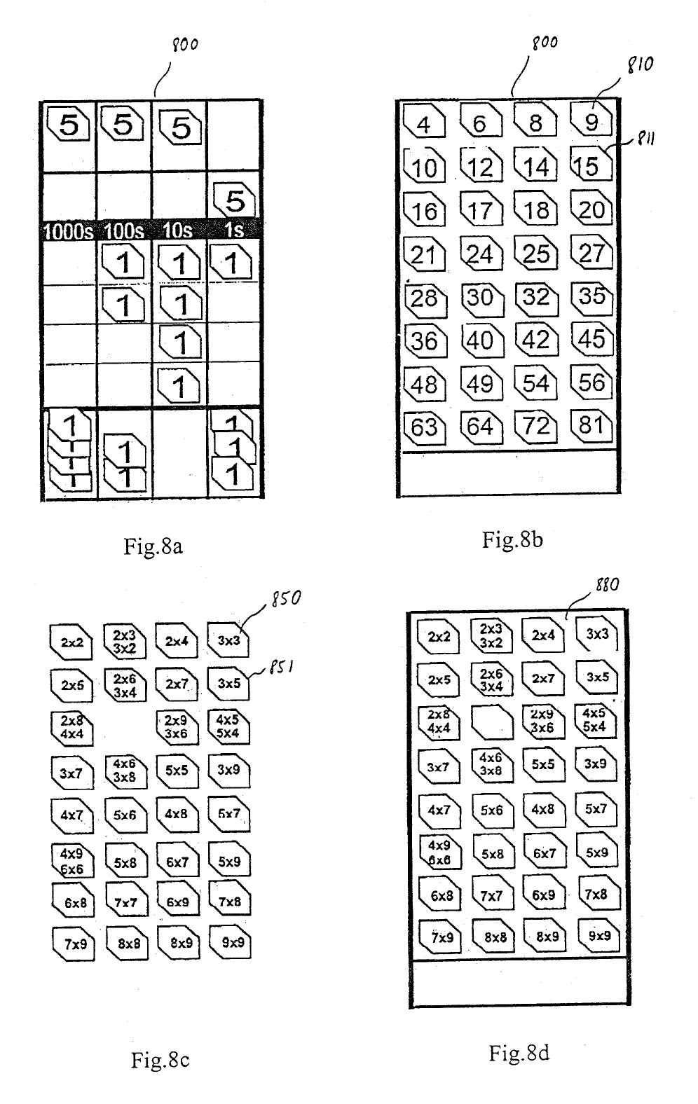

FIG. 8 shows an arrangement for abacus-like calculation according to an eighth embodiment of the present invention. This eighth embodiment is designed for educational purposes and provides a convenient way to check the answers on mathematical tasks employed for training multiplication operations. FIG. 8a shows the upper side A of the board 800. FIG. 8b shows the lower side B of the board 800. Side A of the board 800 is the same as the embodiment of the invention shown in FIG. 6c. Therefore FIG. 8a will not be described once more.

As can be seen from FIG. 8b the lower side B of the board 800 comprises a plurality of printed markings 810 wherein each marking represents a decimal system value. The shape of the side B is formed in a relief structure in the shape of a symmetric sexangle 811 such that each printed marking is located deeper than the upper surface of the side B of the board 800. The relief structure is accomplished by two layers (not shown in FIG. 8b) wherein the upper layer comprises cut out symmetric sexangles 811. It is clear that the relief structure can also be obtained in a milling process.

FIG. 8c shows a plurality of removable numeral plates 850 which have also the shape of a symmetric sexangles 851 in order that they can be inserted in the relief structure located on side B of the board 800. The removable numeral plates 850 comprise printed markings on their upper side. The printed markings display the product of two decimal system values wherein each factor is in the range between the decimal system values two and nine. The removable numeral plates 850 shown in FIG. 8c are distributed in an array such that their arrangement corresponds to the relief structure shown in FIG. 8b. As one can see from FIG. 8c no removable numeral plate 850 is found in the cell defined by the third row and the second column of the array. This is the case because the prime number seventeen can not be decomposed into a product of two factors.

FIG. 8d shows an answer checking device 880 corresponding to the lower side B of the board 800. The answer checking device 880 comprises a transparent plastic overlay with pre-printed numerals, wherein the distribution of the numerals correspond to the printed markings of those removable numeral plates 850 which have been mathematically correct inserted into the relief structure shown in FIG. 8b.

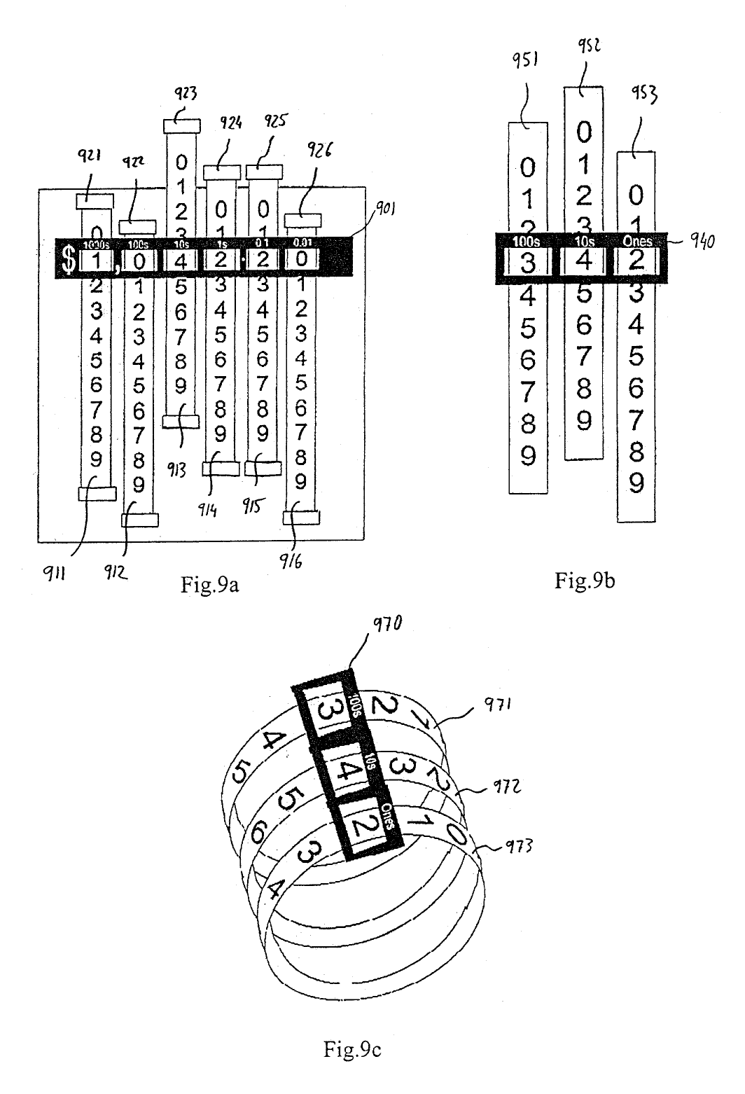

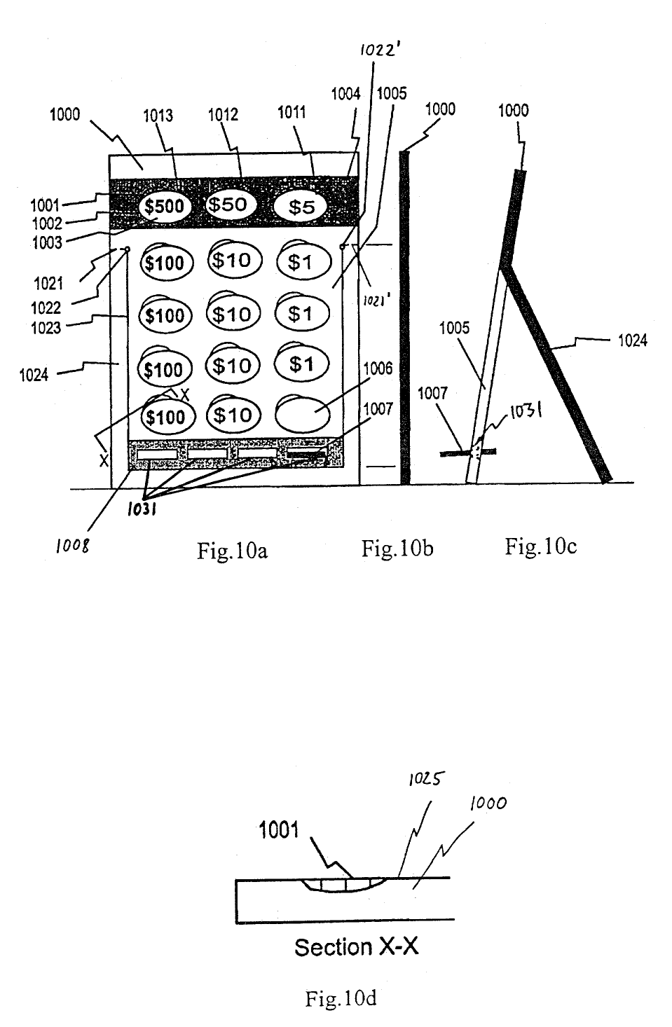

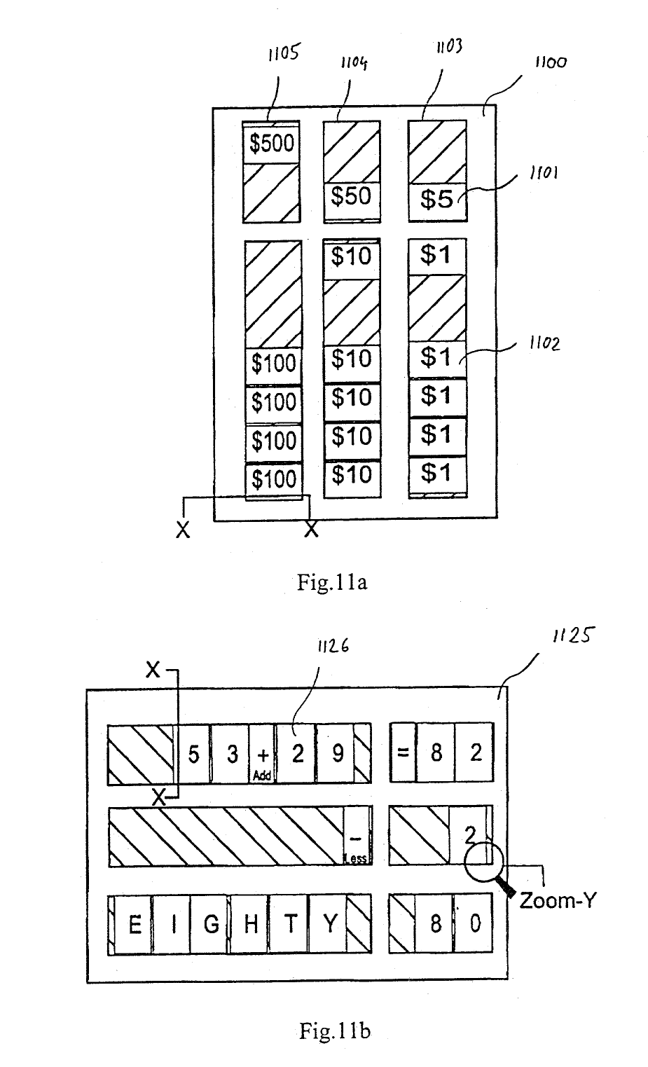

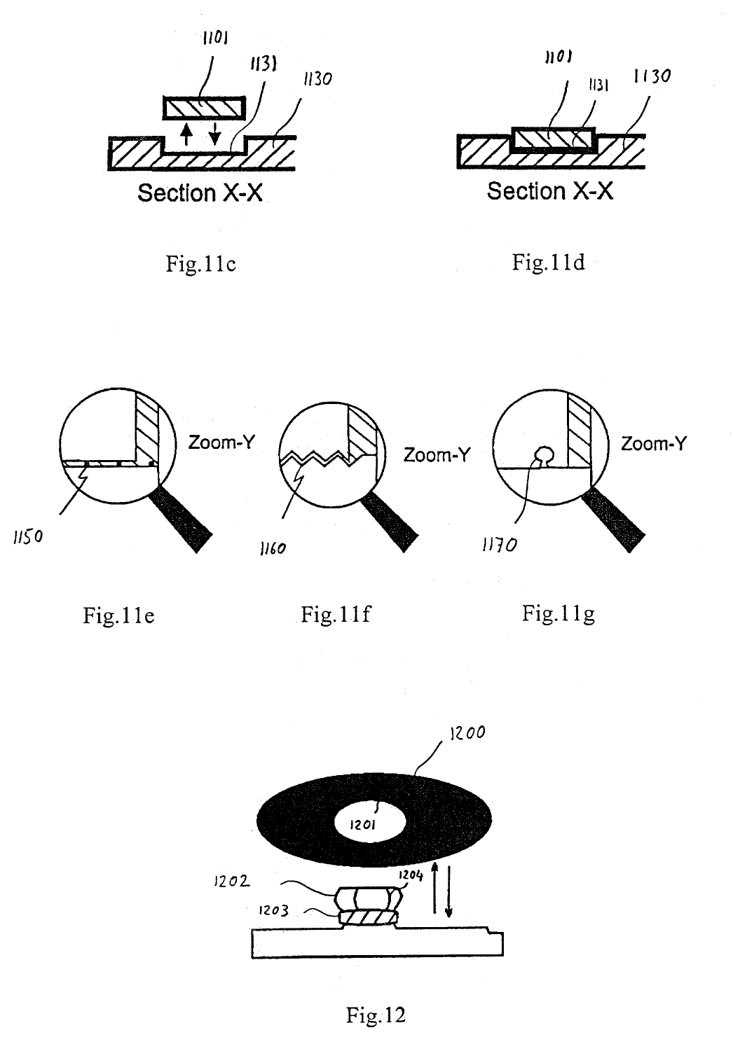

FIG. 9a shows an arrangement for abacus-like calculation according to a ninth embodiment of the present invention. As can be seen from FIG. 9a the arrangement comprises a fixed series of aligned windows representing an indicator device 901. The indicator device 901 has six printed markings located above each window in order to indicate the decimal system place values 0.01, 0.1, 1, 10, 100 and 1000. The arrangement for abacus-like calculation further comprises strips 911, 912, 913, 914, 915 and 916. On each of the strips 911, 912, 913, 914, 915 and 916 there are printed decimal system numbers (0, 1, 2, 3, 4, 5, 6, 7, 8, 9). It has to be pointed out that of course the strips 911, 912, 913, 914, 915 and 916 could also comprise other form of markings such as alphabetical letters in order to convert the calculation device into a vocabulary ‘board’. According to this embodiment of the present invention each strip 911, 912, 913, 914, 915 and 916 has enlarged ends 921, 922, 923, 924, 925 and 926 in order to prevent the strips 911, 912, 913, 914, 915 and 916 from slipping out of the sash. The indicator device 901 can be fixed to a board or to a hand held unit (not shown in FIG. 9a).

FIG. 9b shows a slight modification of the ninth embodiment of the present invention which is similar to the embodiment shown in FIG. 9a. As can be seen from FIG. 9b the arrangement for abacus-like calculation comprises an indicator device 940 which itself comprises three aligned windows. The arrangement for abacus-like calculation further comprises three strips 951, 952 and 953 wherein on the upper side of each strip 951, 952 and 953 there are printed decimal system numbers (0, 1, 2, 3, 4, 5, 6, 7, 8, 9). By contrast to the embodiment shown in FIG. 9a the strips 951, 952 and 953 do not comprise enlarged ends.

FIG. 9c shows a modified three-dimensional alternative version of the ninth embodiment shown in FIG. 9b. The modification compared to the above described embodiment is such that the three strips 971, 972 and 973 are coiled such that the two ends of each strip 971, 972 and 973 are joined together. Therefore the arrangement for abacus-like calculation forms a three-dimensional device. The joining could be performed reversible or irreversible. A reversible way of joining two ends would be by employing velcro tapes. An irreversible way of joining two ends would be by employing double side adhesive tapes.

The arrangement for abacus-like calculation shown in FIG. 9c can be conveniently used as a counter or as a calculator. When using the arrangement as a counter the movement direction of the stripes 971, 972 and 973 can be bi-directional (forward or backward) or unidirectional. For bi-directional movement of the stripes 971, 972 and 973 indents could be employed which have the shape of a hemisphere. Therefore the position of the stripes 971, 972 and 973 relative to the indicator device 970 could be caught after shifting the stripes 971, 972 and 973. For unidirectional movement of the stripes 971, 972 and 973 a saw type blade profile (not shown) can be employed on both the indicator device 970 and the stripes 971, 972 and 973. Further on limits could be set on the highest possible number by placing a stopper which is appropriately shaped and placed at the highest placed value in order to prevent a further rotational movement of the stripes 971, 972 and 973 relative to the indicator device 970.

FIG. 10a shows an arrangement for abacus-like calculation according to a tenth embodiment of the present invention. This embodiment can be deemed as a variation of the eighth embodiment. The arrangement for abacus-like calculation according to the tenth embodiment comprises a thick cardboard 1000. Following the rules of the Chinese abacus the cardboard 1000 is divided into two parts, an upper part 1004 and a lower part 1005. The cardboard 1000 comprises three regions 1011, 1012 and 1013. Each region 1011, 1012 and 1013 comprises five cells 1006, wherein one cell of each region in located in the upper part 1004 of the cardboard 1000 and four cells are located in the lower part 1005 of the cardboard 1000. The cardboard further comprises an area 1008 which will be described later.

Each cell 1006 of the regions 1011, 1012 and 1013 is formed in a recess structure which is capable of receiving a token 1003. According to the present invention the tokens 1003 have an oval shape enabling that the tokens 1003 fit into the recess structured cells. The structure of each cell 1006 has also a predominantly oval shape formed by an oval wall 1002. A bulge 1001 is formed at the upper left part of the oval wall 1002 leading to a depressed space which is useful for manually removing tokens 1003 out of the recess structured cells 1006. In particular a finger lifting of the tokens 1003 is facilitated in particular if the upper surface of the tokens 1003 is leveled with the surface of the cardboard 1000. The oval wall 1002 and the bulge 1001 grips the token 1003 in its place. The depressed spaces 1001 can be cut, milled and/or formed by a press machine. The oval wall 1002 and the bulge 1001 can be a small part of the space that borders the token or they can be formed all around the token 1003. Further it is understood that there are numerous ways to create a relative height difference between the token 1003 and the surface of the cardboard 1000, which also facilitates a manually lifting of the tokens 1003.

According to this tenth embodiment of the present invention the tokens 1003 are marked with following the denotations “$1”, “$5”, “$10”, “$50”, “$100” or ‘$500’. Following the rules of the Chinese abacus tokens marked with “$1”, “$10” or “$100” have to be inserted into recess structured cells 1006 located in the lower part 1005 of the cardboard 1000 and tokens marked with “$5”, “$50” or “$500” have to be inserted into recess structured cells 1006 located in the upper part 1004 of the cardboard 1000.

The area 1008 comprises a plurality of through holes 1031. The width of the through holes 1031 is equal to the minimal width of the tokens 1003. Therefore the through holes 1031 are capable of temporary receiving unused/displaced tokens 1007. The through holes 1031 are provided in order to help the users to organize their tokens.

The cardboard 1000 further comprises a die cut line 1023 which runs in a U-shape from a first end point 1022 to a second end point 1022′. A first score line 1021 runs from the first end point 1022 perpendicular to the left border of the cardboard 1000. A second score line 1021′ runs from the second end point 1022′ perpendicular to the right border of the cardboard 1000. A U-shaped stand 1024 is bordered by the left border of the cardboard 1000, by the lower border of the cardboard 1000, by the right border of the cardboard 1000, by the second score line 1021′, by the die U-shaped cut line 1023 and by the first score line 1021. The stand 1024 can be fold out of the plane of the cardboard 1000. The two score lines 1021 and 1021′ facilitate the folding of the stand 1024 out of the plane of the cardboard 1000. The two end points 1022 and 1022′ are end circular points of the die cut line 1023.

FIG. 10b shows a first side view of the arrangement for abacus-like calculation shown in FIG. 10a. The stand 1024 is not fold out of the plane of the cardboard 1000. Only one side face of the cardboard 1000 can be seen.

FIG. 10c shows a second side view of the arrangement for abacus-like calculation shown in FIG. 10a. The stand 1024 is fold out of the plane of the cardboard 1000. With the help of the fold out stand 1024 the cardboard 1000 is able to stand stable in a predominately vertically position. Due to the fold out stand 1024 the lateral border of the lower part 1005 of the cardboard 1000 is visible. Further on an unused token 1007 can be seen in FIG. 10c which is inserted in one of the through holes 1031.

FIG. 10d shows a sectional view of the cardboard 1000 along the line X-X shown in FIG. 10a. The course of the depressed space 1001 is illustrated. The depressed space 1001 can be used in order to facilitate finger lifting of a token in particular when the upper surface of the token is leveled with the upper surface 1025 of the cardboard 1000.

FIG. 11a shows an arrangement for abacus-like calculation according to an eleventh embodiment of the present invention. As can be seen from FIG. 11a the board 1100 is arranged in a portrait orientation. Similar to the embodiments shown in FIGS. 8a, 8b, 8c, 8d and 10a the eleventh embodiment employs marked tokens which have to be moved in order to perform abacus-like calculations. Since the functionality of the arrangement has been described in detail before it will not be described once more. The following description of FIG. 11a will focus on the way how the tokens 1101 and 1102 and the board 1100 are formed and how the tokens 1101 and 1102 are positioned on the board 1100. The board 1100 comprises three regions 1103, 1104 and 1105. According to the rule of the Chinese-type abacus each region 1103, 1104 and 1105 is divided into an upper and a lower sub-region. Each sub-region comprises two or six cells. According to the embodiment shown in FIG. 11a the cells of the regions 1103, 1104 and 1105 are rectangular relief structured slots which are nestled in the main board 1100. If the user wants to move the tokens 1101 the user has to take out the token 1101 from the slot and place the token 1101 in another slot.

FIG. 11b shows a slight modification of the eleventh embodiment of the present invention which is similar to the embodiment shown in FIG. 11a. By contrast to the embodiment shown in FIG. 11a the board 1125 shown in FIG. 11b is arranged in a landscape orientation. The embodiment shown in FIG. 11b further differs from the embodiment shown in FIG. 11a in that, that the tokens 1126 are marked with different symbols such as symbols for mathematical operations (addition, multiplication, division and subtraction), numbers or alphabetical letters.

FIGS. 11c and 11d show sectional views along the line X-X indicated in FIGS. 11a and 11b. As can be seen from FIG. 11c the token 1101 is taken out from the slot 1131. By contrast thereto, the sectional view of FIG. 11d shows the token 1101 which is inserted in the slot 1131.

FIGS. 11e, 11f and 11g show different possibilities for lateral interfaces between the tokens and the slots, which lateral interfaces can be used for the embodiments of the present invention as illustrated in FIGS. 11a, 11b, 11c and 11d. The interfaces shown in FIGS. 11e, 11f and 11g are enlarged views of the Zoom-Y area indicated in FIG. 11b. All interface profiles are matched male-female profiles. The interface profile shown in FIG. 11e comprises stubs or stumps 1150. In particular this profiled interface can be employed in a beneficial way when a board is used which is made out of a waste product which arises when tokens are produced using a die cutting technique and when the produced tokens have been torn off the board. The interface profile shown in FIG. 11f is a saw-tooth profile 1160. The saw-tooth profile increases the interface area which can be responsible for the frictional grip between the token and the slot. The interface profile shown in FIG. 11f comprises a matched male-female structure which can be described as a defined puzzle profile. The female recess is capable of receiving a male protuberance 1170. The male protuberance 1170 can be described as having a similar shape like a mushroom. The profiled interface shown in FIG. 11f is also able to increase the frictional grip between the token and the slot. A high friction at the lateral interface between the token and the slot is in particular beneficial when this high friction allows that the board can be held upside down without causing the tokens to fall out of the slots. In this case magnetic tokens on a metal board can be avoided leading to the advantage that the arrangement for abacus-like calculation according to the eleventh embodiment of the present invention can be manufactured at significantly lower costs. At this point it has to be emphasized that of course also other profiles or any hybrid combination of between the different profiles shown in FIGS. 11e, 11f and 11g can be employed as the lateral token-slot interface. For example, clear-cut or clean-cut lateral walls, even without serration, with a just-fit surroundings can hold token relatively well, due to its fibrous lateral wall that creates sufficient friction as in the case of hard cardboard material. Another feature would be a bevelled or slanted lateral wall in order to ensure that a token is removable only from one side of the board.

FIG. 12 illustrates a further possibility for positioning a special type token on a particular cell according to a twelfth embodiment of the invention. The special type token 1200 is a circular object which has an inside hole 1201. When this possibility for positioning a token is used, it is beneficial that the corresponding cardboard is produced by machine pressing, wherein a circular raised platform 1202 is created at the center of the particular cell to be occupied by the circular token 1200. In this case a relief structure can be found on the outer edges of the circular raised platform 1202. The lower part of the circular raised platform 1202 is shrink wrapped into a neck shape by means of a elastic ring 1203. For instance the elastic ring can be a rubber band. The portion above the neck has slits 1204 to allow a straddling of the upper part of the circular raised platform 1202. In this case a token can be attached to the circular raised platform 1202 similar to the way a compact disc is being securely placed into a compact disc holder.

What is claimed is:

1. Arrangement for abacus-like calculation with
a basic element comprising
a first region with an array of first cells forming the first region, wherein each first cell represents a visual marking as to an assignment of each first cell,
a second region with an array of second cells forming the second region, wherein each second cell represents a visual marking as to an assignment of each second cell,
at least one first indicator unit accessed to the first region, wherein the relative arrangement between the first indicator unit and the first region is changeable in order to indicate a selected first cell of the array of first cells, and
at least one second indicator unit accessed to the second region, wherein the relative arrangement between the second indicator unit and the second region is changeable in order to indicate a selected second cell of the array of second cells,
wherein the visually marked assignment is marked on the basic element or on the indicator unit.

2. Arrangement according to claim 1, wherein the visual markings represent
numbers of a predefined number system,
symbols represented by different colors,
symbols represented by different color codes,
symbols represented by different characters,
symbols represented by different pictures,
symbols represented by different icons and/or
any other type of distinguishable symbols.

3. Arrangement according to claim 1, wherein the visual markings of the first region represent the decimal system unit-place values and the visual markings of the second region represent the decimal system ten-place values.

4. Arrangement according to claim 2, wherein in case the visual markings represent numbers of a predefined number system
a region is divided into two sub-regions and
each cell of the first sub-region is counted multiple in comparison with the cells belonging to the second sub-region.

5. Arrangement according to claim 1, wherein the basic element is made out of plastic, cardboard, paper, a magnetic material, a clothed-based material and/or any material which provides or which is coated with a write-erasable surface.

6. Arrangement according to claim 1, wherein the indicator unit is made out of plastic, c cardboard, paper, a magnetic material, a clothed-based material and/or any material which provides or which is coated with a write-erasable surface.

7. Arrangement according to claim 1, wherein the basic element comprises a further region being suitable for displaying further information.

8. Arrangement according to claim 7, wherein the region being suitable for displaying further information is used for displaying advertisements.

9. Arrangement according to claim 1 further comprising a calendar, an arithmetic game and/or an attractive display.

10. Arrangement according to claim 1 comprising further a region for indication of a mathematical operation.

11. Arrangement according to claim 10, wherein the mathematical operation is one of the following operations:
addition,
subtraction,
multiplication and/or
division.

12. Arrangement according to claim 1, wherein the first indicator unit and/or the second indicator unit are attached to the basic element via
magnetic interaction,
electrostatic interaction,
gravitational interaction,
sticking,
clamping,
a frictional wall grip and/or
a recess and relief structure.

13. Arrangement according to claim 1, wherein the basic element is a board.

14. Arrangement according to claim 13, wherein the board has a rectangular or a circular shape.

15. Arrangement according to claim 13, wherein the board is a one-piece board or the board is made out of subunits which can reversible or irreversible be connected to each other.

16. Arrangement according to claim 13, wherein the first region and the first indicator unit are arranged on the upper side of the board and the second region and the second indicator unit are arranged on the lower side of the board.

17. Arrangement according to claim 13, wherein the board is made out of a waste product which arises when tokens are produced using a die cutting technique.

18. Arrangement according to claim 13, wherein the board is made out of plastic, foam rubber, wood, metal, corrugated paper, cardboard and/or cork.

19. Arrangement according to claim 13, wherein the board further comprises a component which can be fold out of the plane of the board.

20. Arrangement according to claim 13, wherein
the indicator unit is a sash and
the board comprises grooves or raised shoulders, which are capable of receiving at least a part of the sash.

21. Arrangement according to claim 20, wherein the grooves or raised shoulders have closed ends in order to prevent that indicator units can easily be removed and/or get lost.

22. Arrangement according to claim 13, wherein
the indicator unit has a three-dimensional shape, which sectional profile is similar to the shape of a butterfly or which sectional profile is similar to a system consisting of two isosceles triangles placed opposite to each other while being connected to each other via a triangle vertex,
the board comprises a slot and
the indicator unit is attached to the board in that way, that the slot of the board and the point of intersection of the indicator unit coincide.

23. Arrangement according to claim 12, wherein the first indicator unit and/or the second indicator unit comprise a plurality of individual sub-elements.

24. Arrangement according to claim 23, wherein the individual sub-element is a token or a numeral plate.

25. Arrangement according to claim 23, wherein the upper surface of the individual sub-elements is not leveled with the upper surface of the board.

26. Arrangement according to claim 23, wherein the individual sub-elements comprise serrated lateral walls.

27. Arrangement according to claim 23, wherein the individual sub-elements have a circular shape with an inside hole and the board comprises circular raised platforms.

28. Arrangement according to claim 24, wherein the numeral plate can be reversibly taken away from or placed back onto the board.

29. Arrangement according to claim 24, wherein the numeral plates are sliding numeral plates which are movably attached to the board.

30. Arrangement according to claim 1, wherein the first indicator unit and the second indicator unit are integrally formed within one single piece.

31. Arrangement according to claim 30, wherein the first indicator unit is a first window and the second indicator unit is a second window.

32. Arrangement according to claim 31, wherein
the first region has the shape of a first strip,
the second region has the shape of a second strip,
the first strip is movably attached to the first indicator unit and
the second strip is movably attached to the second indicator unit.

33. Arrangement according to claim 32, wherein
the first strip comprises a series of first numeral markings located such that one of the first numeral markings can be placed in the middle of the first window and
the second strip comprises a series of second numeral markings located such that one of the second numeral markings can be placed in the middle of the second window.

34. Arrangement according to claim 32, wherein the first strip and/or the second strip comprise enlarged ends in order to prevent the first strip and/or the second strip from slipping out of the first window and/or the second window, respectively.

35. Arrangement according to claim 32, wherein the first and the second strip are coiled such that the two ends of each strip are joined together.

36. Arrangement according to claim 1, which is simulated by a computer program.
